(19) United States
(12) Patent Application Publication
(10) Pub. No.: US 2023/0305902 A1
(43) Pub. Date: Sep. 28, 2023

(54) RESOURCE QUANTITY ESTIMATION APPARATUS, RESOURCE QUANTITY ESTIMATION METHOD AND PROGRAM

(71) Applicant: NIPPON TELEGRAPH AND TELEPHONE CORPORATION, Tokyo (JP)

(72) Inventors: Koji SUGISONO, Tokyo (JP); Shinya KAWANO, Tokyo (JP); Hiroki KANO, Tokyo (JP); Akihiro KIMURA, Tokyo (JP); Katsuma MIYAMOTO, Tokyo (JP)

(21) Appl. No.: 18/006,778

(22) PCT Filed: Aug. 25, 2020
(86) PCT No.: PCT/JP2020/032029

§ 371 Date: Jan. 25, 2023

(51) Int. Cl. G06F 9/50; G06F 17/18; G06F 11/34

(52) U.S. Cl. CPC G06F 9/5055; G06F 17/18; G06F 11/3433

(57) ABSTRACT

A resource amount estimation device includes: an acquisition unit configured to acquire, in response to a request for allocation of a resource, a measurement value of an amount of the resource, a measurement time of the measurement value, and statistical information relating to the resource; and a calculation unit configured to input a measurement value acquired by the acquisition unit and an elapsed time from the measurement time to a scheduled allocation time of the resource into a model that estimates the resource amount in the future on the basis of the statistical information and to calculate an estimation value of the resource amount at the scheduled allocation time, and thus increases the possibility of resource allocation appropriate to a point in time when the resource is allocated being performed.

### TECHNICAL FIELD

The present invention relates to a resource amount estimation device and a resource amount estimation method and program.

### BACKGROUND ART

With the development of virtual machine technology and software defined network (SDN) technology, it has become possible to provide network services to service users by providing data processing functions on demand in the form of a virtual machine or a container when the users want to use them and dynamically setting a communication path between the functions. In response to such a situation, in the past, a serverless computing model which is charged only during the resource usage period has appeared as a service for low usage rate users who have paid a flat rate for each period regardless of the amount of usage to reduce service use costs.

In the serverless computing model, resources are allocated on demand and the resources are released after processing is completed. Therefore, it has a feature that resource allocation and communication between virtual machines occur in a burst.

One requirement for reducing the usage fee is to shorten the processing time. The processing time varies depending on the usage rate of physical calculation resources such as servers or links used by a calculation function and a communication function. The processing time can be shortened by allocating a calculation function and a communication function to an unoccupied device. In order to allocate calculation/communication functions to a device having a low resource usage rate, a technique of deriving an unoccupied device or a communication path and allocating calculation/communication functions for serverless computing processing while considering requirements such as a CPU and an estimated amount of communication data required for serverless computing processing and physical calculation resources for service has been studied for many years.

### CITATION LIST

### Non Patent Literature

[NPL 1] A. Fischer et al., “Virtual Network Embedding: A Survey,” IEEE COMMUNICATIONS SURVEYS & TUTORIALS, VOL. 15, NO. 4, pp. 1888-1906, FOURTH QUARTER 2013.

### SUMMARY OF INVENTION

### Technical Problem

In the related art, when allocation locations of a calculation function and a communication function have been calculated, the allocation locations have been calculated by aggregating resource information such as the amount of data or the CPU usage rate from a server, a network switch, or the like into an allocation location calculation function and applying the aggregated resource information to an algorithm or the like.

Here, the point to be considered is the freshness of resource information used, that is, the amount of elapsed time from the measurement time of the resource information to the calculation point in time of the allocation location.

Usually, a time lag occurs due to the influence of data transfer delay, processing delay, or the like until measurement data arrives from the physical resource to the allocation location calculation function. Therefore, there is an error between resource information referred to by the allocation location calculation function at the calculation point in time and statistical information observed by a server or a switch that has transmitted the resource information at the calculation point in time.

Therefore, even though the allocation location calculation function calculates an optimum allocation location on the basis of the obtained resource information, there is a possibility that the situation will change when a path is actually allocated and an optimum solution will not be obtained.

The present invention was contrived in view of the above points, and an object thereof is to increase the possibility of resource allocation appropriate for a point in time when the resource is allocated being performed.

### Solution to Problem

Consequently, in order to solve the above problem, there is provided a resource amount estimation device including: an acquisition unit configured to acquire, in response to a request for allocation of a resource, a measurement value of an amount of the resource, a measurement time of the measurement value, and statistical information relating to the resource; and a calculation unit configured to input a measurement value acquired by the acquisition unit and an elapsed time from the measurement time to a scheduled allocation time of the resource into a model that estimates the resource amount in the future on the basis of the statistical information and to calculate an estimation value of the resource amount at the scheduled allocation time.

### Advantageous Effects of Invention

It is possible to increase the possibility of resource allocation appropriate for a point in time when the resource is allocated being performed.

### BRIEF DESCRIPTION OF DRAWINGS

FIG. 1 is a diagram illustrating a system configuration example in an embodiment of the present invention.

FIG. 2 is a diagram illustrating a hardware configuration example of a resource allocation device 10 in a first embodiment.

FIG. 3 is a diagram illustrating a functional configuration example of the resource allocation device in the first embodiment.

FIG. 4 is a diagram illustrating a functional configuration example of a service execution device 20 in the first embodiment.

FIG. 5 is a flowchart illustrating an example of a processing procedure which is executed by the resource allocation device 10 in the first embodiment.

FIG. 6 is a diagram illustrating a probability distribution of the amount of communication resources after 100 msec.

FIG. 7 is a diagram illustrating a specific example of correction of the amount of communication resources.

FIG. 8 is a diagram illustrating generation of a pair of a measurement value for each measurement time and a measurement value after t seconds.

FIG. 9 is a diagram illustrating discretization and generation of a transition pattern.

FIG. 10 is a diagram illustrating a probability of occurrence of a transition pattern.

### DESCRIPTION OF EMBODIMENTS

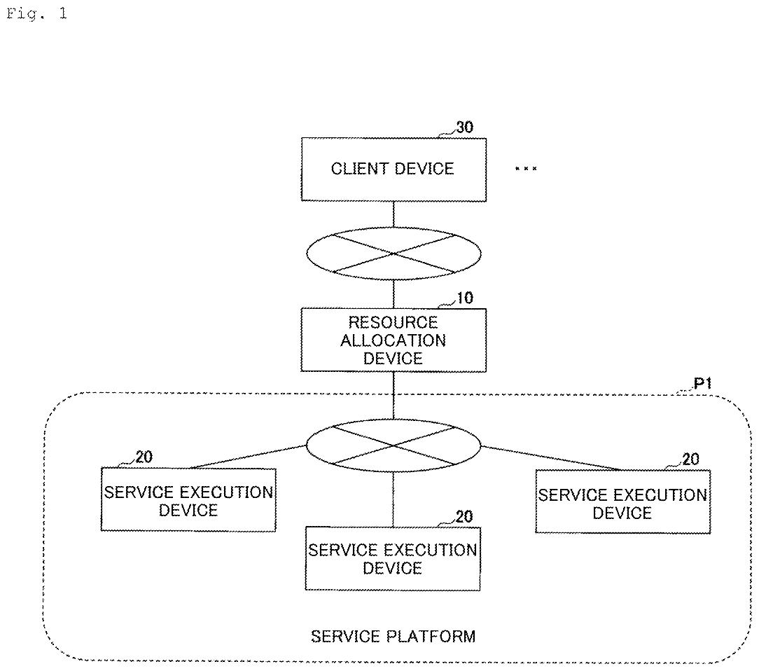

Hereinafter, embodiments of the present invention will be described with reference to the accompanying drawings. FIG. 1 is a diagram illustrating a system configuration example in an embodiment of the present invention. As shown in FIG. 1, a resource allocation device 10 is connected to one or more client devices 30 through a network. The resource allocation device 10 is also connected to a plurality of service execution devices 20 constituting a service platform P1 through a network. Meanwhile, the plurality of service execution devices 20 are connected to each other through a network. Hereinafter, a network section between two pairs of service execution devices 20 is referred to as a “link.”

The service platform P1 is a computer system that provides a predetermined service (for example, a network service) using a virtual machine technique, a software defined network (SDN) technique, or the like. Each service execution device 20 is a computer in which software (a virtual machine (VM) in the present embodiment) for executing processing related to a service is operated.

The client device 30 is a computer that requests the resource allocation device 10 to allocate a system resource (hereinafter simply referred to as a “resource”) required for a service.

The resource allocation device 10 is one or more computers that execute resource allocation according to a request from the client device 30 (hereinafter referred to as a “resource allocation request”) with respect to the service platform P1.

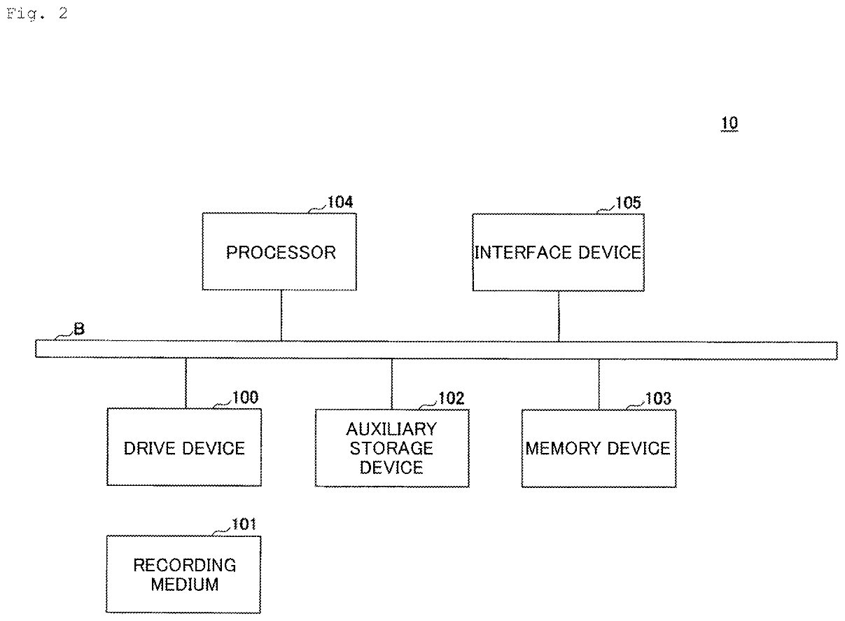

FIG. 2 is a diagram illustrating a hardware configuration example of the resource allocation device 10 in the first embodiment. The resource allocation device 10 of FIG. 2 includes a drive device 100, an auxiliary storage device 102, a memory device 103, a processor 104, an interface device 105, and the like which are connected to each other through a bus B.

A program for realizing processing in the resource allocation device 10 is provided by a recording medium 101 such as a CD-ROM. When the recording medium 101 having a program stored thereon is set in the drive device 100, the program is installed in the auxiliary storage device 102 from the recording medium 101 through the drive device 100. However, the program does not necessarily have to be installed from the recording medium 101, and may be downloaded from other computers through a network. The auxiliary storage device 102 stores the installed program and stores necessary files, data, and the like.

When there is an instruction for starting a program, the memory device 103 reads out the program from the auxiliary storage device 102 and stores the program. The processor 104 is a CPU or a graphics processing unit (GPU), or a CPU and a GPU, and executes a function related to the resource allocation device 10 in accordance with the program stored in the memory device 103. The interface device 105 is used as an interface for connection to a network.

Meanwhile, the client device 30, the service execution device 20, and the like may also have a hardware configuration as shown in FIG. 2.

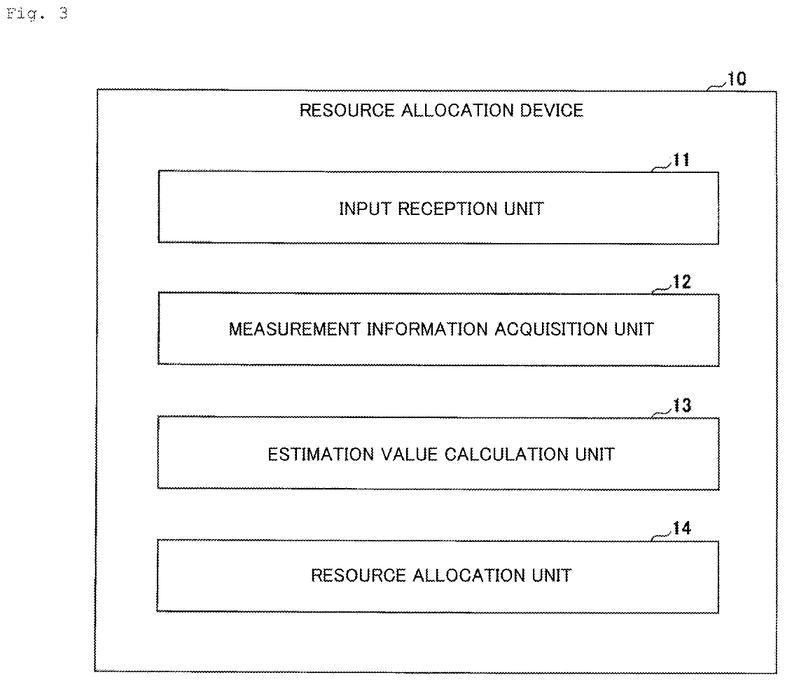

FIG. 3 is a diagram illustrating a functional configuration example of the resource allocation device 10 in the first embodiment. In FIG. 3, the resource allocation device 10 includes an input reception unit 11, a measurement information acquisition unit 12, an estimation value calculation unit 13, a resource allocation unit 14, and the like. Each of these units is realized by one or more programs installed in the resource allocation device 10 causing the processor 104 to execute processing.

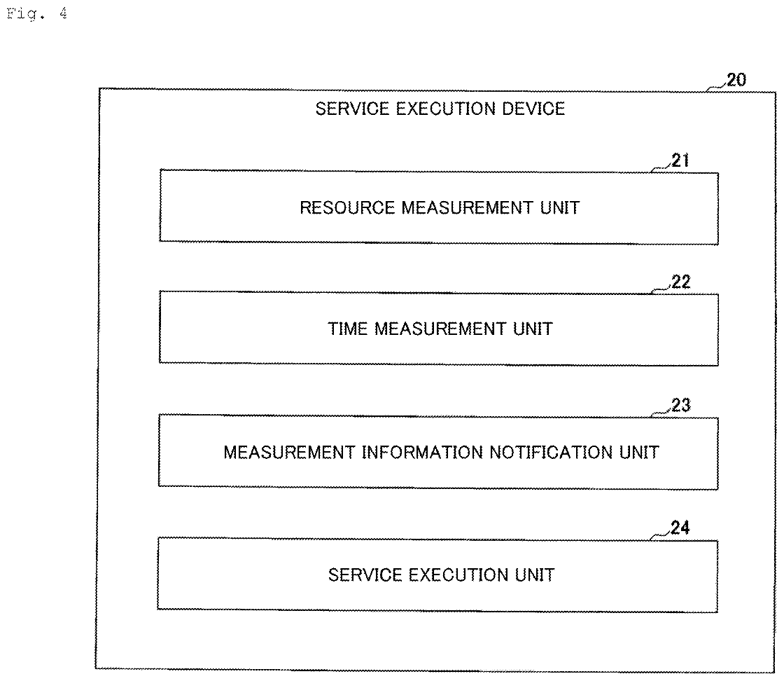

FIG. 4 is a diagram illustrating a functional configuration example of the service execution device 20 in the first embodiment. In FIG. 4, the service execution device 20 includes a resource measurement unit 21, a time measurement unit 22, a measurement information notification unit 23, a service execution unit 24, and the like. Each of these units is realized by one or more programs installed in the service execution device 20 causing the processor of the service execution device 20 to execute processing.

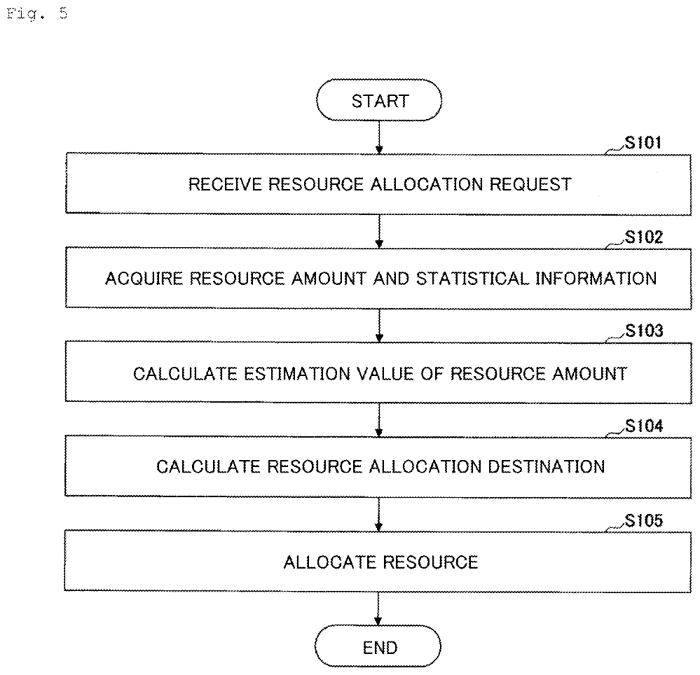

Hereinafter, a processing procedure which is executed by the resource allocation device 10 will be described. FIG. 5 is a flowchart illustrating an example of a processing procedure which is executed by the resource allocation device 10 in the first embodiment.

In step S101, the input reception unit 11 receives a resource allocation request from the client device 30. The resource allocation request includes, for example, information on a VM (hereinafter referred to as “VM information”) that needs to be allocated, a band (for example, 10 Mbps) required for communication between VMs, and the like. The VM information includes, for example, the type (that is, function) of execution processing of the VM, the execution order of each VM, and the like for each required VM.

Next, the measurement information acquisition unit 12 acquires statistical information relating to the amount of resources and the operating status or usage status of resources, or the like from each service execution device 20 and each link that connects the service execution devices 20 (S102). For example, the amount of resources related to calculation processing of a VM (hereinafter referred to as “the amount of calculation resources”) and statistical information (hereinafter referred to as “device statistical information”) such as the usage rate of a processor are acquired from each service execution device 20. For example, the amount of resources related to communication between VMs (hereinafter referred to as “the amount of communication resources”) and statistical information (hereinafter referred to as “link statistical information”) such as an unused band are acquired from each link. Examples of the device statistical information and the link statistical information include an average resource allocation occurrence rate, an average resource allocation time, and the like.

Regarding the service execution device 20, the average resource allocation occurrence rate is the number of VM allocations per unit time, and the average resource allocation time is the average VM operation time related to one allocation. The operation time is a period after a VM is allocated and before the VM is released.

Regarding the link, the average resource allocation occurrence rate is the number of occurrences of a flow per unit time, and the average resource allocation time is the average duration of one flow. Meanwhile, the term “flow” refers to a series of communications between the same communication partners.

Meanwhile, in the present embodiment, it is assumed that the average resource allocation time, average resource allocation occurrence rate, average resource usage amount, and burst traffic generation process of each resource are the same values for each resource allocation request.

The amount of calculation resources and the device statistical information are measured by the resource measurement unit 21 of each service execution device 20. In addition, the amount of communication resources and the link statistical information whose time at a point in time of measurement (measurement time) of the amount of calculation resources and the device statistical information is measured by the time measurement unit 22 of each service execution device 20, and the measurement time thereof is measured by, for example, a network device such as a switch constituting a link.

For example, the measurement information acquisition unit 12 requests each service execution device 20 and each switch to transmit the amount of resources and the statistical information. When the request is received, the resource measurement unit 21 of each service execution device 20 measures the amount of calculation resources at that point in time, and the time measurement unit 22 measures the time at that point in time. The measurement information notification unit 23 of each service execution device 20 transmits the amount of calculation resources and the measurement time of the amount of calculation resources and the device statistical information obtained from the measurement of the amount of resources or the like asynchronous to the request (for example, periodically) to the measurement information acquisition unit 12. In addition, when the request is received, each network device measures the amount of communication resources and the measurement time at that point in time. Each network device transmits the measurement time of the amount of communication resources and the amount of communication resources and the link statistical information obtained from the measurement asynchronous to the request (for example, periodically) to the measurement information acquisition unit 12.

Next, the estimation value calculation unit 13 calculates the estimation value of the future amount of resources, with respect to each resource amount (each amount of calculation resources and each amount of communication resources), by inputting the measurement value of the amount of resources acquired in step S102 and the elapsed time from the measurement time of the amount of resources to the scheduled resource allocation completion time into a model that performs estimation (hereinafter referred to as an “estimation model”) on the basis of each piece of statistical information acquired in step S102 (S103). In the first embodiment, the estimation model is constructed using queuing theory modeled at M/M/100/100. Here, in order to simplify the description, an example in which the amount of communication resources at the scheduled resource allocation completion time is estimated on the basis of the amount of communication resources and the link statistical information will be described. Meanwhile, M/M/100/100 means a model in which the amount of resources that can be allocated is 100 and the maximum value of the amount of resources that can be allocated is 100. For example, a case where a band per flow is 1 Mbps and the maximum value of a band that can be allocated is 100 Mbps corresponds to M/M/100/100.

Here, in a case where the amount of communication resources acquired in step S102 is B (Mbps), the average resource allocation occurrence rate is A, and the average resource allocation time is p, the probability for each band i after t seconds can be calculated on the basis of the following equation of state. Meanwhile, the value of t is the elapsed time from the measurement time of the amount of resources to the scheduled resource allocation completion time. The scheduled resource allocation completion time may be calculated by the estimation value calculation unit 13 on the basis of, for example, the past actual results or the like.

$$[ Math 1 ]$$

$$\frac{d}{dt} P ( t ) = Q P ( t ) \qquad ( 1 )$$

$$P ( t ) = {( P ( 0 , t ) , P ( 1 , t ) , … , P ( 100 , t ) )}^{T}$$

$$Q = ( \begin{matrix}- λ & μ \\ λ & - ( λ + μ ) \\ & ⋮ \\ & 0\end{matrix} \begin{matrix}0 \\ 2 μ \\ \\ \end{matrix} \begin{matrix} \\ ⋯ \\ ⋱ \\ ⋯\end{matrix} \begin{matrix} \\ \\ λ \\ 0\end{matrix} \begin{matrix}0 \\ ⋮ \\ - ( λ + 99 μ ) \\ λ\end{matrix} \begin{matrix} \\ \\ 100 μ \\ - 100 μ\end{matrix} )$$

Here, P(i, t) the probability that the amount of communication resources at time t is i Mbps
P(B, 0)=1
P(i, 0)=0 (i≠B)
Q: state transition matrix

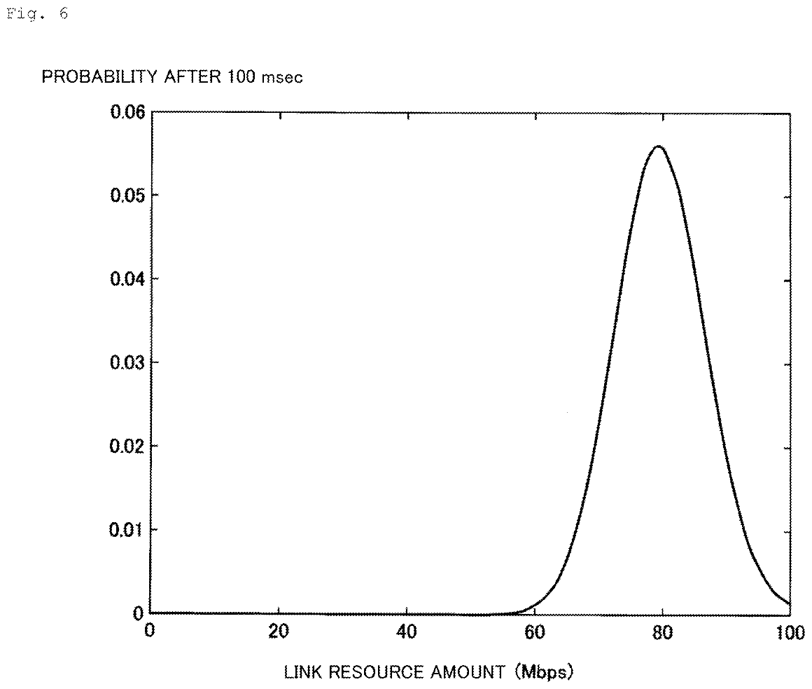

Therefore, in step S103, the estimation value calculation unit 13 calculates Pⱼ(tⱼ) by substituting tⱼ, λj, and μⱼ for t, λ, and μ in Math (1) for each band I in 1 Mbps increments of 0 to 100 Mbps for each link. Meanwhile, tⱼ is the elapsed time from the measurement time of the communication resource of the link j to the scheduled resource allocation completion time. λⱼ is the average resource allocation occurrence rate of the link j. μⱼ is the average resource allocation time of the link j. Pⱼ(tⱼ) is the probability distribution of each band after tⱼ seconds of the link j. For example, when tⱼ=100 msec, Math (1) represents a probability distribution as shown in FIG. 6.

That is, for the link j where t: =100 msec, the estimation value calculation unit 13 calculates Pⱼ(0.1)={Pⱼ(0, 0.1), . . . , Pⱼ(100, 0.1)} with respect to Math (1) to obtain the probability distribution of the band 100 msec after the measurement time.

Next, the estimation value calculation unit 13 calculates the estimation value cⱼ of the band after tⱼ seconds for each link j on the basis of the probability distribution of the band of the link j after tⱼ seconds. As shown in the following Math (2), the expectation value (average value) of the probability distribution is calculated as the estimation value cⱼ.

[Math 2]

[symbol]

cⱼ=ΣiPⱼ(i,tⱼ) (2)

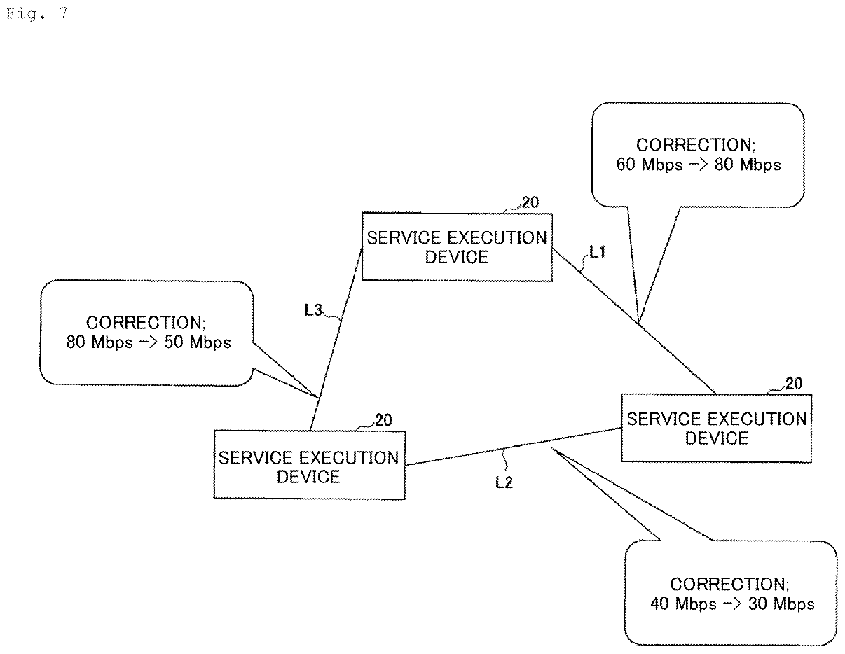

As a result, each amount of communication resources used for path calculation is corrected, for example, as shown in FIG. 7. In FIG. 7, the amount of communication resources (measurement value) during measurement of the link L1 is 60 Mbps, but it is shown that the amount of communication resources (estimation value) at the scheduled resource allocation completion time is corrected to 80 Mbps. In addition, the amount of communication resources (measurement value) during measurement of the link L2 is 40 Mbps, but it is shown that the amount of communication resources (estimation value) at the scheduled resource allocation completion time is estimated to be 30 Mbps. Further, the amount of communication resources (measurement value) during measurement of the link L3 is 80 Mbps, but it is shown that the amount of communication resources (estimation value) at the scheduled resource allocation completion time is estimated to be 50 Mbps.

Meanwhile, although the amount of communication resources has been described above, each amount of calculation resources can also be corrected in the same way (the estimation value at the scheduled resource allocation completion time can be calculated).

Next, the resource allocation unit 14 calculates the service execution device 20 which is a resource allocation destination, a link for allocating a communication path between VMs, and the like on the basis of the estimation value calculated for each resource amount (S104).

Next, the resource allocation unit 14 executes resource allocation according to a resource allocation request on the basis of the calculation result in step S104 (S105).

Meanwhile, steps S104 and S105 may be performed on the basis of known techniques.

Next, a second embodiment will be described. In the second embodiment, differences from the first embodiment will be described. Points which are not particularly mentioned in the second embodiment may be the same as those in the first embodiment.

In the second embodiment, the content of steps S102 and S103 in FIG. 5 is different from that in the first embodiment.

In step S102, the measurement information acquisition unit 12 acquires time-series data of each amount of resources (the amount of calculation resources, the amount of communication resources) from each service execution device 20 and each link. The time-series data is, for example, a history of the amount of resources measured periodically.

In the next step S103, the estimation value calculation unit 13 calculates the estimation value of the resource allocation completion time (t seconds after the measurement time) for each amount of resources using the estimation model based on statistical processing based on the time-series data.

The details of the statistical processing will be described. Here, a method of calculating an estimation value for the amount of calculation resources (CPU usage rate) will be described.

First, the estimation value calculation unit 13 acquires a measurement value r1 at the measurement time and a measurement value r2 t seconds after the measurement time for each measurement time of each measurement value of the time-series data, and generates a pair of measurement values of (r1, r2).

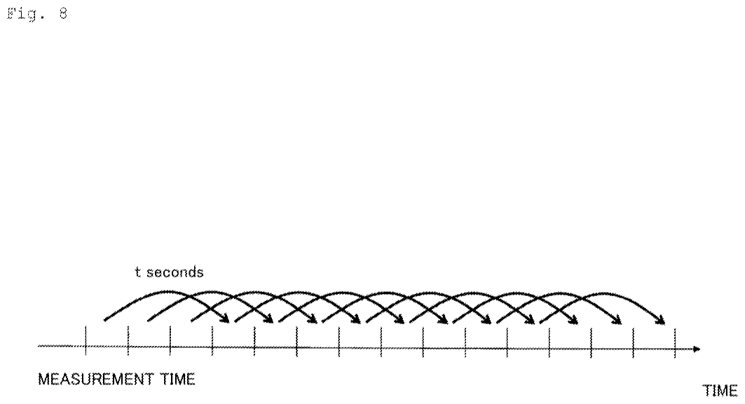

FIG. 8 is a diagram illustrating generation of a pair of a measurement value for each measurement time and a measurement value after t seconds. Each vertical line on the straight line in FIG. 8 indicates a measurement time. Meanwhile, in a case where measurement is not performed at a timing of complete matching after t seconds, the measurement value at the closest measurement time may be acquired after t seconds. Each pair acquired in this way indicates the transition of the measurement value during t seconds.

Next, the estimation value calculation unit 13 discretizes the measurement values r1 and r2 of each pair. Specifically, measurement values included in the same discrete section among discrete sections set in advance are discretized so as to have the same value. For example, discretization may be performed by rounding to the nearest whole number. The estimation value calculation unit 13 generates a graph showing a transition pattern from r1 to r2 on the basis of a discretized pair group.

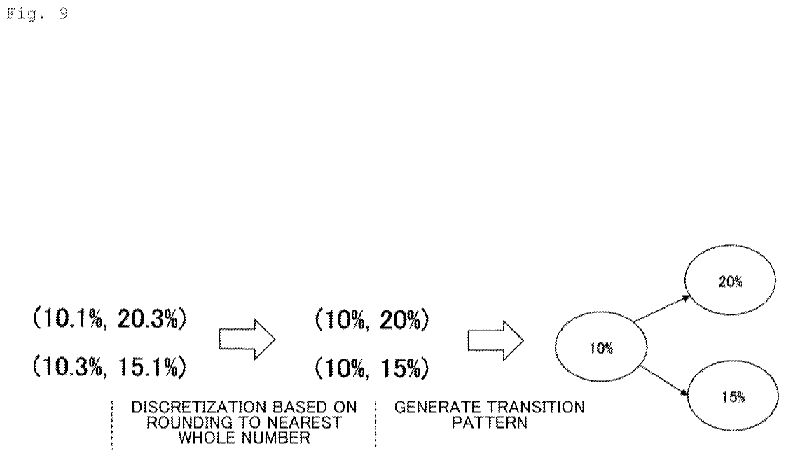

FIG. 9 is a diagram illustrating discretization and generation of a transition pattern. FIG. 9 shows pairs such as (10.1%, 20.3%) and (10.3%, 15.1%). When each of these measurement values is discretized by, for example, rounding to the nearest whole number, each pair becomes (10%, 20%) and (10%, 15%). According to these two pairs, for 10%, it can be seen that there are two transition patterns to 20% or 15% during t seconds. A graph showing this transition pattern is a drawing on the right end in FIG. 9. In the graph, common r1 (transition source) is integrated into the same node (transition source node), and common r2 (transition destination) is integrated into the same node (transition destination node). Hereinafter, the graph is referred to as a “transition graph.”

Next, the estimation value calculation unit 13 calculates the occurrence probability (transition probability from each measurement value) by counting the number of occurrences of each transition pattern for each transition pattern having the same transition source node and dividing the number of occurrences by the total number of transition patterns related to the transition source node.

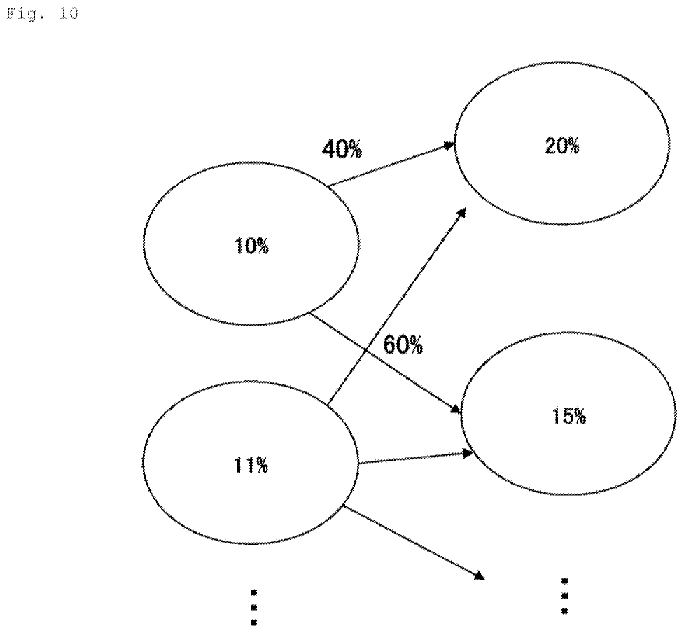

FIG. 10 is a diagram illustrating a probability of occurrence of a transition pattern. FIG. 10 shows that there is a possibility of transition from 10% to 20% or 15% and the transition probabilities are 40% and 60%, respectively. That is, at this stage, each branch of the transition graph is given the occurrence probability (transition probability) of a transition pattern corresponding to the branch. The transition graph in this state serves as an estimation model used in the calculation of the estimation value in the second embodiment.

Next, for each calculation resource, the estimation value calculation unit 13 weights the transition probability of each transition pattern having the measurement value (value acquired in step S102) of the calculation resource as the transition source node, and calculates a weighted average of values of transition destination nodes (amounts of resources) of each transition pattern as the estimation value of the amount of resources at the scheduled allocation completion time.

Step S104 and subsequent steps in FIG. 5 may be the same as those in the first embodiment.

Meanwhile, one transition graph may be generated on the basis of the time-series data from all the service execution devices 20, or may be generated for each service execution device 20. In the latter case, a transition graph based on the time-series data of the service execution device 20 related to a certain calculation resource may be used to calculate the estimation value of the resource amount of the calculation resource.

In addition, although the calculation resource has been described above for convenience, the estimation value calculation unit 13 similarly calculates the estimation value of the amount of resources t seconds after the measurement time for each communication resource.

Next, a third embodiment will be described. In the third embodiment, differences from the first embodiment will be described. Points which are not particularly mentioned in the third embodiment may be the same as those in the first embodiment.

In the third embodiment, an example in which a model based on machine learning is used as an estimation model will be described. Meanwhile, in the third embodiment, for convenience, a calculation resource will be described.

In the third embodiment, learning of the estimation model is executed in the following procedures (1) to (3) before the processing procedure of FIG. 5 is executed. The estimation model may use a neural network, or may use another model.

(1) The measurement information acquisition unit 12 acquires statistical information (for example, the number of operating VMs and the type of execution processing of each VM) on the measurement time, the amount of calculation resources, and software (VM) that uses resources related to the amount of resources which are recorded by the resource measurement unit 21 of each service execution device 20 at the periodic measurement time, as learning data, from each service execution device 20. That is, time-series data including the measurement time, the amount of resources, and the statistical information at each measurement point in time is acquired.

(2) The estimation value calculation unit 13 used the time-series data as learning data and causes the estimation model to learn a transition relationship between the measurement time, the amount of resources, and the statistical information. For example, the transition pattern as described in the second embodiment is learned by the estimation model. In this case, the type of execution processing may be replaced with, for example, a numerical value indicating each type. Meanwhile, the estimation model is a function that uses time, the amount of resources, and the statistical information as inputs and outputs an estimation value of the amount of resources at the time.

(3) After a technician identifies outputs performed by the estimation model, an output determined to be significant may be input to the estimation model again and the estimation model may be relearned.

Meanwhile, as the estimation model, a model common to all the service execution devices 20 may be trained, or learning may be performed for each service execution device 20.

In the third embodiment, the processing procedure of FIG. 5 is executed in a state where the estimation model has already been trained.

In step S102, the measurement information acquisition unit 12 acquires the calculation resource at the current point in time, the measurement time of the calculation resource, and the statistical information (for example, the number of operating VMs and the type of execution processing each VM) of the service execution device 20 at the current point in time from each service execution device 20.

In step S103, the estimation value calculation unit 13 inputs the calculation resource acquired from the service execution device 20, the time t seconds after the measurement time of the calculation resource (that is, the scheduled resource allocation completion time), and the statistical information of the service execution device 20 at the current point in time into a trained AI system for each service execution device 20, and calculates the estimation value of the calculation resource at the scheduled resource allocation completion time. Meanwhile, in a case where the estimation model is constructed for each service execution device 20, the estimation value calculation unit 13 uses an estimation model trained for the service execution device 20 for each service execution device 20.

Step S104 and subsequent steps in FIG. 5 may be the same as those in the first embodiment.

Meanwhile, although the calculation resource has been described above for convenience, the estimation value calculation unit 13 similarly calculates the estimation value of the amount of resources t seconds after the measurement time for each communication resource.

As described above, according to each of the embodiments, the amount of resources at the measurement point in time is corrected to the estimation value at the scheduled resource allocation completion time on the basis of the model based on the statistical information relating to the resource. Therefore, even in a case where there is a time lag between a point in time when the resource amount is measured and a point in time when the resource is allocated, it is possible to increase the possibility of resource allocation appropriate to a point in time when the resource is allocated being performed. As a result, for example, the VM processing time and the VM communication time are reduced, and the reduction of service use costs can be expected.

Meanwhile, in each of the embodiments, the resource allocation device 10 is an example of a resource amount estimation device.

Although an embodiment of the present invention has been described in detail above, the present invention is not limited to the specific embodiment described above, and various modifications and changes can be made within the concept of the present invention described in the claims.

### REFERENCE SIGNS LIST

10 Resource allocation device
11 Input reception unit
12 Measurement information acquisition unit
13 Estimation value calculation unit
14 Resource allocation unit
20 Service execution device
21 Resource measurement unit
22 Time measurement unit
23 Measurement information notification unit
24 Service execution unit
30 Client device
100 Drive device
101 Recording medium
102 Auxiliary storage device
103 Memory device
104 Processor
105 Interface device
B Bus
P1 Service platform

1. A resource amount estimation device comprising:
a processor; and
a memory storing program instructions that cause the processor to:
acquire, in response to a request for allocation of a resource, a measurement value of a resource amount of the resource, a measurement time of the measurement value, and statistical information relating to the resource; and
input the measurement value and an elapsed time from the measurement time to a scheduled allocation time of the resource into a model that estimates the resource amount in the future on the basis of the statistical information and calculate an estimation value of the resource amount at the scheduled allocation time.

2. The resource amount estimation device according to claim 1, wherein the model is a model using queuing theory, statistical processing, or machine learning.

3. The resource amount estimation device according to claim 1, wherein the statistical information includes an average resource allocation occurrence rate and an average resource allocation time related to the resource or time-series data of the resource amount.

4. A resource amount estimation method comprising
acquiring, in response to a request for allocation of a resource, a measurement value of a resource amount of the resource, a measurement time of the measurement value, and statistical information relating to the resource; and
inputting the acquired measurement value and an elapsed time from the measurement time to a scheduled allocation time of the resource into a model that estimates the resource amount in the future on the basis of the statistical information and calculating an estimation value of the resource amount at the scheduled allocation time.

5. The resource amount estimation method according to claim 4, wherein the model is a model using queuing theory, statistical processing, or machine learning.

6. The resource amount estimation method according to claim 4, wherein the statistical information includes an average resource allocation occurrence rate and an average resource allocation time related to the resource or time-series data of the resource amount.

7. A non-transitory computer-readable recording medium storing a program configured to cause a computer to execute the resource amount estimation method according to claim 4.
